(19) United States
(12) Patent Application Publication
(10) Pub. No.: US 2009/0028308 A1
(43) Pub. Date: Jan. 29, 2009

(54) CALL HANDLING SYSTEM WITH VISUAL CALL MENU

(75) Inventors: Kevin J. Pieper, Coral Springs, FL (US); Changxue Ma, Barrington, IL (US); Kevin S. Olcott, Cary, NC (US); John P. Wasko, Palm Beach Garden, FL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/781,978

(22) Filed: Jul. 24, 2007

(51) Int. Cl. H04M 3/42

(52) U.S. Cl. 379/93.17

(57) ABSTRACT

A method (600) and a system (102) for processing an incoming call (104). The method can include receiving the incoming call from a communication device (106, 108) and determining whether the communication device is configured to present a visual call menu. When the communication device is configured to present the visual call menu, the visual call menu can be communicated to the communication device. The present invention also relates to a method and a communication device for establishing a call. The method can include placing a call to a call handling system from a communication device, and receiving a visual call menu from the call handling system. The visual call menu can be presented on a display (120, 122, 508) associated with the communication device.

### BACKGROUND OF THE INVENTION

1. Field of the Invention

The present invention generally relates to telecommunications and, more particularly, to automated call systems.

2. Background of the Invention

The use of automated call answering systems has become commonplace among businesses, especially those businesses that deal with large volumes of incoming calls. When a telephone call is automatically answered using such a system, an automated voice usually recites to the caller a set of instructions for navigating a call menu, for example, “welcome to our call answering system, please press 1 for sales, press 2 for service,” and so on. Oftentimes the caller must also traverse a number of submenus, each of which provides further instructions, before the caller finally reaches a desired point in the menu hierarchy. Moreover, after that point is reached, the caller oftentimes is placed on hold until desired information is obtained or a person with whom the caller wishes to communicate answers the call. Interfacing with such automated call answering systems in this manner can be very time consuming and frustrating. The frustration level is compounded even further if the caller enters in a wrong selection while traversing the call menu, in which case the caller may be required to restart the entire menu navigation process.

Presently available call answering systems also are inconvenient for callers who use conventional telephone handsets. Such a caller usually must place the handset next to his ear to listen to a set of instructions, and then remove the handset from his ear so that he may depress an appropriate key that corresponds to a desired menu selection. After the key has been depressed, the caller then must place the handset back to his ear to listen to the next set of instructions. Oftentimes this process is performed multiple times before the caller reaches a desired point in the menu hierarchy.

Once the caller does reach the desired menu point, he often needs to remember specific information that is being communicated. Some callers have difficulty remembering such information, especially if the information is long. If a caller does not have a writing instrument and paper readily available to inscribe the information when the information is received, he may need to call back and again navigate the call menu system to once again retrieve the information.

### SUMMARY OF THE INVENTION

The present invention relates to a method and a call processing system for processing an incoming call. The method can include receiving the incoming call from a communication device and determining whether the communication device is configured to present a visual call menu. When the communication device is configured to present the visual call menu, the visual call menu can be communicated to the communication device.

The present invention also relates to a method for establishing a call. The method can include placing a call to a call handling system from a communication device, and receiving a visual call menu from the call handling system. The visual call menu can be presented on a display associated with the communication device.

Another aspect of the present invention relates to a communication device. The communication device can include a communications adapter that places a call to a call handling system and receives a visual call menu from the call handling system. The communication device further can include a display that presents the visual call menu.

The present invention also relates to a computer program product including a computer-usable medium having computer-usable program code that, when executed, causes a machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts an example of a visual call menu that is useful for understanding the present invention;

FIG. 3 depicts another example of a visual call menu that is useful for understanding the present invention;

FIG. 4 depicts an example of a call handling system that is useful for understanding the present invention;

FIG. 5 depicts an example of a communication device that is useful for understanding the present invention;

FIG. 6 is a flowchart that is useful for understanding the present invention; and

FIG. 7 is another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

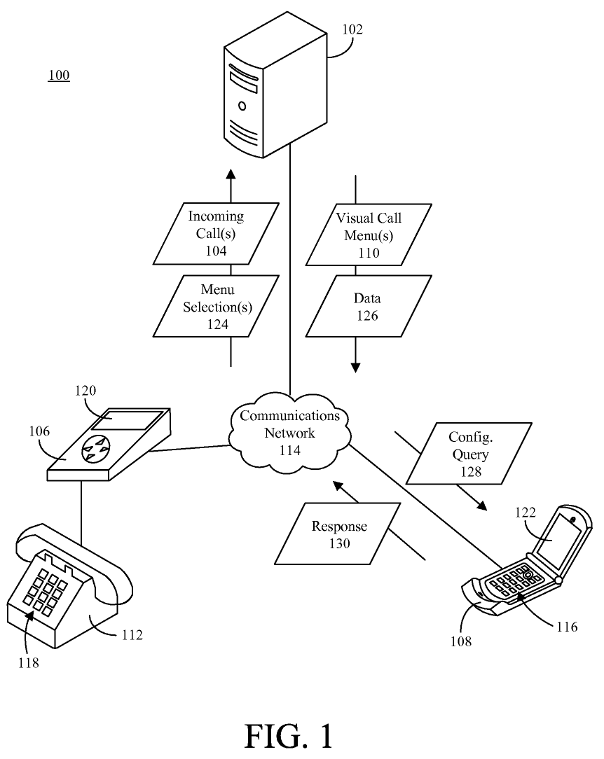

FIG. 1 depicts a communications system 100 that is useful for understanding the present invention. The communications system 100 can include a call handling system 102 that is configured to automatically process incoming calls 104 received from one or more communication devices 106, 108. During such call processing, the call handling system 102 can communicate visual call menus 110 to the communication devices 106, 108 for presentation to users, thereby facilitating user selection of call menu items.

The communication devices 106, 108 can be, for example, telephones, mobile stations (e.g. mobile telephones, mobile radios, mobile computers, personal digital assistants, or the like), computers, set top boxes, wireless gaming devices, access terminals, subscriber stations, gaming consoles, user equipment, or any other devices that may be suitably configured to communicate with a call answering center. In one arrangement, one or more of the communication devices, for instance the communication device 106, can be an application specific apparatus that is suitably configured to provide an interface between the call handling system 102 and another communication device 112 which does not include a display, for instance a conventional telephone.

The calls 104 and visual call menus 110 can be propagated via a communications network 114. The communications network 114 can comprise any network infrastructure suitable for communicating audio to the incoming calls 104 and visual call menus 110. For example, the communications network 114 can comprise a public switched telephone network (PSTN) and/or a wide area network (WAN), such as the Internet, the World Wide Web, a cellular communications network, and the like. Other examples of suitable network infrastructure may include, but are not limited to, an integrated services digital network (ISDN), a radio access network (RAN), a local area network (LAN), a metropolitan area network (MAN), a WiFi network, a Mesh network, a public safety network (e.g. Astro, TETRA, HPD, etc), and any other networks or systems over which communication signals can be propagated. In that regard, the communications network 114 can include wired and/or wireless communication links.

In operation, a communication device 106, 108 can place a call 104 to the call handling system 102 by dialing a telephone number that is associated with the call handling system 102. For example, the telephone number can be dialed to call the call handling system 102 directly, or the telephone number can be dialed to call another device or system which forwards the call 104 to the call handling system 102.

The telephone number associated with the call handling system 102 can be dialed in any suitable manner. For example, a user of the communication device 108 can dial the telephone number by selecting an alphanumeric sequence (e.g. using one or more keys 116, buttons or a touch screen), selecting a contact or telephone number from a contact list, uttering at least one identifier associated with the telephone number, etc. Systems that implement such telephone number dialing techniques are well known to those skilled in the art.

In an arrangement in which the communication device 106 is communicatively linked to the communication device 112, the call 104 can be placed by dialing the telephone number using the communication device 106 or the communication device 112. For example, a user can enter a telephone number using the communication device 112 (e.g. by depressing keys 118). Optionally the communication device 106 can detect the telephone number that was dialed, and store the telephone number so that at another time the number can be dialed by selecting a menu item on the communication device 106. In another arrangement, the telephone number can be dialed by entering the telephone number into the communication device 106, and the telephone communication device 112 can be used merely as an input/output audio device.

Regardless of the manner in which the telephone number is dialed, the call handling system 102 can answer the call 104. During the call session, the call handling system 102 can communicate a visual call menu 110 to the communication device 106, 108 from which the call was received. The visual call menu 110 can be communicated along with, or in lieu of, audio information. For example, a call center representative can speak with a communication device user while the visual call menu 110 is being communicated and/or presented on the communication device 106, 108. Further, the user can be provided an option to proceed exclusively in a data mode using visual call menus 110 or exclusively in audio mode.

The visual call menus 110 can be communicated in any suitable manner. For example, the visual call menus 110 can be communicated as text and/or graphics data communicated using a short message service (SMS). Notably, the use of text or simple graphics data can consume less network bandwidth than audio, thereby reducing network loading. The visual call menus 110 can be presented on a respective display 120, 122 associated with the communication device 106, 108 from which the call was received. The displays 120, 122 can be incorporated into the respective communication devices 106, 108, or otherwise communicatively linked to the communication devices 106, 108.

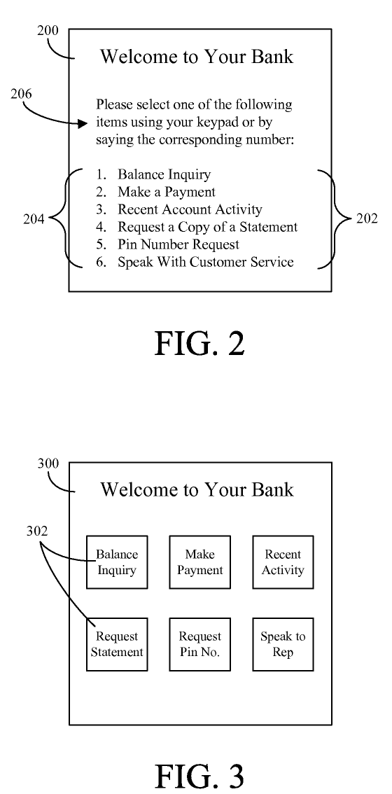

Referring briefly to FIG. 2, an example visual call menu 200 is shown. The example visual call menu 200 can present one or more menu items 202 and indicators that indicate to a user how to select one or more of such menu items 202. For example, the example visual call menu 200 can include one or more alphanumeric indicators 204 associated with each of the menu items 202. The example visual call menu 200 also can include text 206 that indicates to a user how to select a desired menu item 202, for example by depressing a particular key or button corresponding to the alphanumeric indicator 204 associated with the desired menu item 202. The user also can select a menu item 202 by uttering the alphanumeric indicator 204 or uttering other terms associated with the menu item, for instance by uttering the text presented in the menu item 202.

Referring briefly to FIG. 3, another example of a visual call menu 300 is shown. The visual call menu 300 can present user selectable icons 302. In one arrangement, a user can make a menu selection by selecting an icon 302 using a cursor. The cursor may be controlled in any suitable manner, for instance using a keypad. In an arrangement in which the menu 300 is presented on a touch screen, a user can make a menu selection by selecting an icon 302 using a stylus or an appendage. Still, menu items can be selected from the visual call menu 200 or the visual call menu 300 in any other suitable manner and the invention is not limited in this regard.

Again referring to FIG. 1, the selected menu item 124 can be communicated from the communication device 106, 108 to the call handling system 102. In response to the selected menu item 124, the call handling system 102 can perform a call handling operation. For example, if sub-menu items are associated with the selected menu item 124, the call handling system 102 can communicate to the communication device 108 one or more additional visual call menus 110 that include the sub-menu items. If the selected menu item 124 identifies a particular call recipient, the call handling system 102 can route the call to the identified call recipient. The call handling system 102 also can perform any other functions indicated by the menu selection 124 and the invention is not limited in this regard.

In one aspect of the inventive arrangements, if a user requests data 126 from the call handling system 102, for instance by selecting a particular menu item in the visual call menu 110, the call handling system 102 can communicate such data 126 to the communication device 106, 108 from which the request was generated, for example communication device 108. The data 126 also can be communicated at the behest of the call handling system 102 or another user, for instance a call center representative.

The communication device 108 can process the data and/or store the data 126. In one arrangement, the communication device 108 can store the data 126 as a text message. The data 126 also can be stored in a data table, a data file, or in any other suitable manner. Accordingly, the data 126 can be available for use by the communication device 108 and/or the user at another time. For example, the data 126 can be automatically retrieved in response to an event, such as receiving another visual call menu on the communication device 108, manually retrieved by the user, or retrieved in any other suitable manner. By way of example, the data 126 can include account information, such as an account number and password, and such information can be retrieved and communicated back to the call handling system 102 during a login process when another incoming call 104 is placed from the communication device 108 to the call handling system 102.

In another aspect of the inventive arrangements, prior to propagating the visual call menus 110 to a communication device, for instance the communication device 108, the call handling system 102 can communicate a message 128 querying whether the communication device 108 is configured to present the visual call menu(s) 110. For example, the message can prompt the communication device 108 to provide a response 130 that indicates whether it is configured to receive and present visual call menus 110. Such indication can be based on capabilities of the communication device 108 and/or settings of the communication device 108. For instance, if the communication device 108 lacks a display or visual menu presentation is turned off in its device settings, the response 130 can indicate that the communication device is not configured to present visual call menus 110.

If the communication device 108 is not configured to present the visual call menu, the call handling system 102 can communicate an audio call menu to the communication device. For example, the call handling system 102 can communicate audio information that indicates to a user a set of instructions for navigating a call menu. The communication device 108 then can audibly present such instructions to the user in a conventional manner.

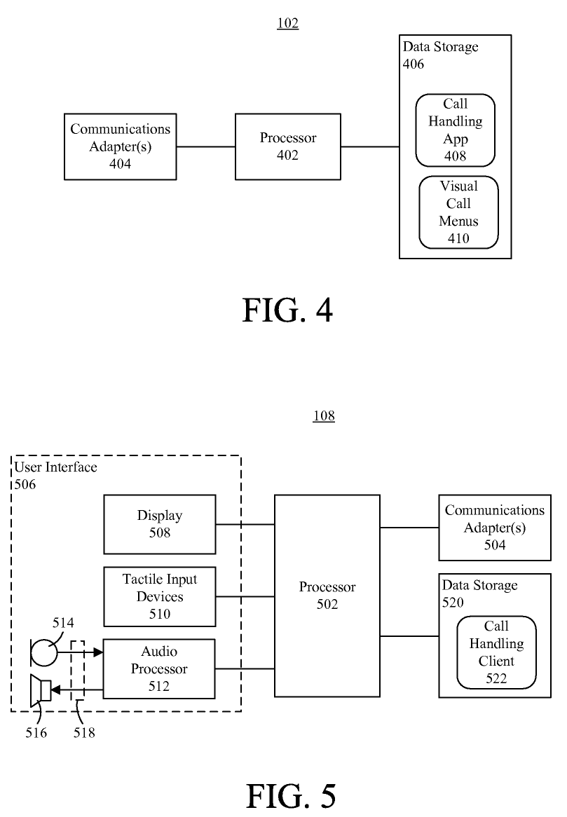

FIG. 4 depicts an example of the call handling system 102 that is useful for understanding the present invention. The call handling system 102 can include a processor 402. The processor 402 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The call handling system 102 also can include one or more communication adapters 404 which the call handling system 102 may use to communicate with communication devices. For example, the communication adapters 404 can be used to send and receive audio, text, data, or any other information communicated between the call handling system 102 and the communication devices. The communication adapter(s) 404 can include one or more wired and/or wireless communications modems suitably configured to communicate via a communications network to which the call handling system 102 is communicatively linked. Communications modems are known to the skilled artisan.

The call handling system 102 further can include a data storage 406. The data storage 406 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 406 can be integrated into the processor 402, though this need not be the case.

A call handling application 408 and visual call menus 410 can be contained on the data storage 406. The call handling application 408 can be executed by the processor 402 to implement the methods and processes described herein which are performed by the call handling system 102. For example, the call handling application 408 can receive incoming calls from communication devices and query such devices to determine if they are capable of presenting the visual call menus 410. The call handling application 408 also can select suitable visual call menus 410 and communicate such visual call menus 410 to the communication devices. Further, the call handling application 408 can receive menu selections from the communication devices and perform functions indicated by the menu selections. Still, the call handling application 408 can perform any other suitable call handling functions, and the present invention is not limited in this regard.

FIG. 5 depicts an example of a communication device 108 (or 106) that is useful for understanding the present invention. The communication device 108 can include a processor 502. The processor 502 can comprise, for example, one or more CPUs, one or more DSPs, one or more ASICs, one or more PLDs, a plurality of discrete components that can cooperate to process data, and/or any other suitable processing device. In an arrangement in which a plurality of such components are provided, the components can be coupled together to perform various processing functions as described herein.

The communication device 108 also can include one or more communication adapters 504 which the communication device 108 may use to place calls and otherwise communicate and exchange messages with the call handling system 102. For example, the communication adapters 504 can be used to send and receive audio, text, data, or any other information communicated between the communication device 108 and the call handling system. The communication adapter(s) 504 can include one or more wired and/or wireless communications modems suitably configured to communication via a communications network to which the communication device 108 is communicatively linked. For example, a communication adapter 504 can be configured to communicate over a conventional telephone line, an ISDN line, the Internet, the World Wide Web, a cellular communications network, and so on. As noted, communications modems are known to the skilled artisan.

The communication device 108 further can include a user interface 506 comprising a display 508. The display 508 can be a liquid crystal display (LCD), a liquid crystal on silicon (LCOS) display, a cathode ray tube (CRT), a plasma display, or any other suitable display. The user interface 506 also can include one or more tactile input devices 510. The tactile input devices 510 can comprise one or more buttons, keys, soft keys, sensors, or any other devices suitable for receiving a tactile user input and communicating such input to the processor 502. In one arrangement, one or more tactile input devices 510 can be integrated with the display 508. For instance, the display 508 can comprise a touch screen that can receive tactile inputs from an appendage and/or a stylus.

The user interface 506 further can include an audio processor 512. The audio processor 512 can be integrated with the processor 502 or provided as a separate component that is communicatively linked to the processor 502. The audio processor 512 can comprise a CPU, a DSP, an ASIC, a PLD, a plurality of discrete components that cooperate to process audio data, and/or any other suitable audio processing device.

The audio processor 512 can be operatively connected to an input audio transducer 514 (e.g. microphone) and an output audio transducer 516 (e.g. loudspeaker) such that the audio processor 512 can process audio information received from the input audio transducer 514 and/or process audio information presented via the output audio transducer 516. In one arrangement, the input audio transducer 514 and output audio transducer 516 can be components of the communication device 108.

In another arrangement, the input audio transducer 514 and/or the output audio transducer 516 can be components of another communication device to which the communication device 108 is communicatively linked, for example a conventional telephone. In such an arrangement, the audio processor 512 can be configured to interface with such other communication device, for instance via a connector 518. The connector 518 can be, for example, a telephone socket (e.g. an RJ-11 or RJ-45 socket) configured to receive a telephone connector. The telephone socket can be communicatively linked to the audio processor 512 in any suitable manner.

Further, additional devices (not shown) can be components of the user interface 506. For instance, the user interface 506 also can include a headset, a speakerphone, and/or other device(s) communicatively linked to the communication device 108.

The communication device 108 further can include a data storage 520. The data storage 520 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 520 can be integrated into the processor 502, though this need not be the case.

A call handling client 522 can be contained on the data storage 520. The call handling client 522 can be executed by the processor 502 to implement the methods and processes described herein which are performed by the communication device 108 (or the communication device 106). For example, via the communications adapter 504, the call handling client 522 can receive a message from the call handling system querying the communication device 108 to indicate whether it is configured to present visual call menus, and respond to such query. The call handling client 522 also can receive visual call menus from the call handling system via the communications adapter 504, present the visual call menus on the display 508, and receive user inputs via the tactile input devices 510. Further, the call handling client 522 can communicate certain user inputs, such as menu selections, to the call handling system via the communications adapter 504. In addition, the call handling client 522 can store data received from the call handling system.

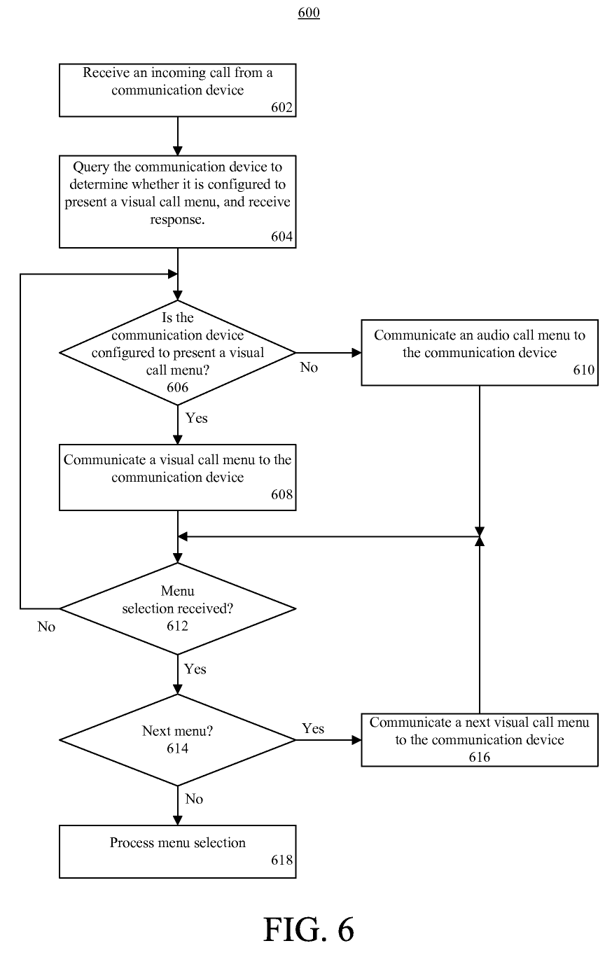

FIG. 6 is a flowchart presenting a method 600 that is useful for understanding the present invention. Beginning at step 602, a call processing system can receive an incoming call from a communication device. At step 604, the call processing system can communicate a message to the communication device. The message can query the communication device to determine whether the communication device is configured to present a visual call menu. The call processing system can receive a message from the communication device responding to the query and indicating whether the communication device is configured to present a visual call menu.

Continuing to decision box 606, if the communication device is configured to present a visual call menu, the process can proceed to step 608 and a visual call menu can be communicated to the communication device. If, however, the communication device is not configured to present a visual call menu, at step 610 an audio call menu can be communicated to the communication device. A determination can be made that the communication device is not configured to present a visual call menu if a response is received from the communication device indicating such, or if a response to the query communicated at step 604 is not received from the communication device within a particular time frame.

Referring to decision box 612, if a menu selection is not received, for example within a desired time frame, the process can return to decision box 606 and an appropriate call menu can be communicated to the communication device. If, however, a menu selection is received from the communication device before a timeout, the process can proceed to step 614 and a determination can be made whether the menu selection indicates another menu should be presented to the user. If so, at step 616 another visual call menu can be communicated to the communication device for presentation to the user. For example, a sub-menu corresponding to the menu selection can be communicated to the communication device. If the menu selection does not indicate another menu should be presented to the user, at step 618 the menu selection can be suitably processed. For example, if the menu selection identifies a destination for the call, the call can be routed to an appropriate destination. If the menu selection identifies requested information, and the caller is authorized to receive such information, the information can be communicated to the communication device.

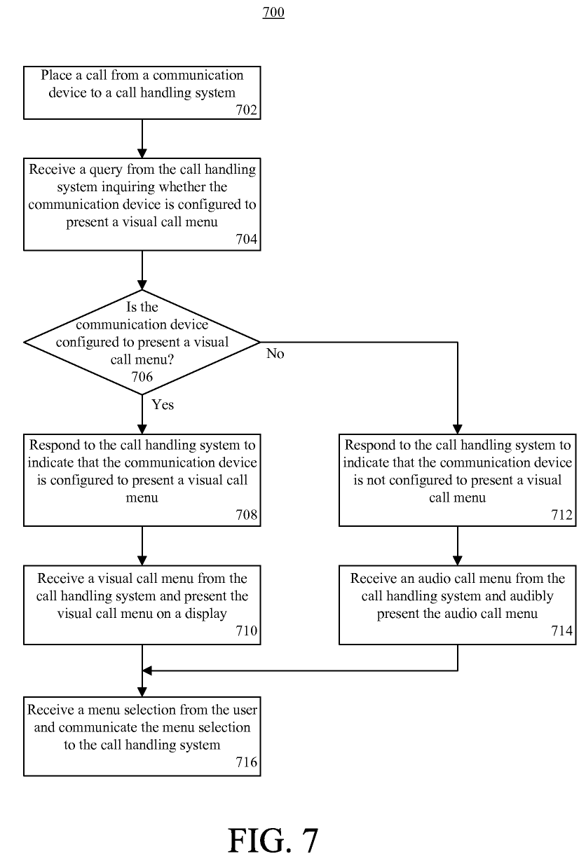

FIG. 7 is a flowchart presenting another method 700 that is useful for understanding the present invention. Beginning at step 702, a call can be placed from a communication device to a call handling system. At step 704, the communication device can receive a query from the call handling system inquiring whether the communication device is configured to present a visual call menu. Proceeding to decision box 706, if the communication device is configured to present the visual call menu, at step 708 the communication device can respond to the call handling system to indicate that the communication device is configured to present a visual call menu. At step 710 a visual call menu can be received from the call handling system and presented to the user on a display associated with the communication device.

Referring again to decision box 706, if the communication device is not configured to present a visual call menu, the process can proceed to step 712 and the communication device can respond to the call handling system to indicate that it is not configured to present a visual call menu. Proceeding to step 714, the communication device can receive an audio call menu from the call handling system and audibly present the audio call menu to the user.

The determination that the communication device is not configured to present a visual call menu can be made in any suitable manner. For instance, such determination can be made if visual call menu presentation is turned off on the communication device (e.g. in user settings or other device settings). The determination that the communication device is not configured to present a visual call menu also can be made if the state of the communication device is not ready to present a visual call menu. The communication device may not be ready to present a call menu, for example, if the display associated with the communication device is being used for another purpose, for instance text messaging, gaming, etc.

Referring to decision box 716, regardless of the type of call menu presented to the user, the communication device can receive a menu selection from the user and communicate the menu selection to the call handling system.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A method of processing an incoming call, comprising:
receiving the incoming call from a communication device;
determining whether the communication device is configured to present a visual call menu; and
when the communication device is configured to present the visual call menu, communicating the visual call menu to the communication device.

2. The method of claim 1, wherein communicating the visual call menu comprises communicating graphics to the communication device.

3. The method of claim 1, wherein communicating the visual call menu comprises communicating text to the communication device.

4. The method of claim 1, wherein determining that the communication device is capable of presenting the visual call menu comprises:
communicating a message to the communication device requesting a response indicating whether the communication device is configured to present the visual call menu.

5. The method of claim 1, further comprising:
when the communication device is not configured to present the visual call menu, communicating an audio call menu to the communication device.

6. The method of claim 1, further comprising:
receiving from the communication device at least one selection of a visual call menu item; and
responsive to the selection, routing the call in accordance with the selected visual call menu item.

7. The method of claim 1, further comprising:
receiving from the communication device at least one selection of a visual call menu item; and
responsive to the selection, presenting a second visual call menu in accordance with the selected visual call menu item.

8. A method for establishing a call:
from a communication device, placing a call to a call handling system;
receiving a visual call menu from the call handling system; and
presenting the visual call menu on a display associated with the communication device.

9. The method of claim 8, further comprising:
receiving from the call handling system a message querying whether the communication device is configured to present the visual call menu; and
communicating a response to the message that indicates whether the communication device is configured to present the visual call menu.

10. The method of claim 8, further comprising:
receiving a menu selection via a tactile input device; and
communicating the menu selection to the call handling system.

11. The method of claim 10, further comprising:
receiving data from the call handling system corresponding to the menu selection; and
storing the data to a data storage.

12. The method of claim 8, further comprising presenting audio information via an output audio transducer of a second communication device communicatively linked to the communication device.

13. The method of claim 8, further comprising receiving audio information via an input audio transducer of a second communication device communicatively linked to the communication device.

14. The method of claim 8, further comprising presenting audio information via an output audio transducer of a telephone communicatively linked to the communication device.

15. The method of claim 8, further comprising receiving audio information via an input audio transducer of a telephone communicatively linked to the communication device.

16. A communication device, comprising:
a communications adapter that places a call to a call handling system and receives a visual call menu from the call handling system; and
a display that presents the visual call menu.

17. The communication device of claim 16, wherein the communications adapter receives from the call handling system a message querying whether the communication device is configured to present the visual call menu, and communicates a response to the message that indicates whether the communication device is configured to present the visual call menu.

18. The communication device of claim 16, further comprising:
a tactile input device that receives a menu selection;
wherein the communications adapter communicates the menu selection to the call handling system.

19. The communication device of claim 16, wherein the communication device presents audio information via an output audio transducer of a second communication device communicatively linked to the communication device.

20. The communication device of claim 16, wherein the communication device receives audio information via an input audio transducer of a second communication device communicatively linked to the communication device.
